(19) United States
(12) Patent Application Publication
(10) Pub. No.: US 2004/0062782 A1
(43) Pub. Date: Apr. 1, 2004

(54) Addition of insect repellent during rinse cycle

(76) Inventor: John Van Winkle, Walton, KY (US)

Correspondence Address: TAFT, STETTINIUS & HOLLISTER LLP, SUITE 1800, 425 WALNUT STREET, CINCINNATI, OH, 45202-3957, US

(21) Appl. No.: 10/262,456

(22) Filed: Oct. 1, 2002

(51) Int. Cl. A01N 25/00; B32B 5/02; B32B 27/04; B32B 27/12

(52) U.S. Cl. 424/405; 442/123

(57) ABSTRACT

The present invention includes a method of manufacturing an article of manufacture comprising the steps of manufacturing a fabric softener and, including an amount of an insect repellent as a component of the fabric softener. The invention also includes a method of imparting insect repellence to an article comprising the step of adding an amount of insect repellent to an article within a washing machine during a rinse cycle. In one exemplary embodiment, the present invention utilizes DEET, N,N-diethyl-m-toluamide, as the insect repellent.

### BACKGROUND

1. Field of the Invention

The present invention relates to a method of applying an insect repellent to articles as part of the rinse cycle of a clothes washer. In particular the invention is directed to a method of delivering DEET, N,N-diethyl-m-toluamide, during the rinse cycle of the clothing to impart insect repellence and thereby protect the wearer from insect bites, such as by mosquitoes and ticks.

2. Background of the Invention

Many types of insects are classified as pests, and many efforts have been made to eradicate or, at the very least, control them. Notwithstanding the development of effective poisons, which have been substantially effective in controlling insects such as mosquitoes, it has been found that many poisons, a case in point being the chemical commonly known as DDT, have undesirable effects on human and other animal life and therefore uses of many are now regulated or forbidden.

Often, an effective repellent is the only feasible means to prevent mosquito bites which may produce an allergic reaction or transmit a virus. Generally regarded as the most effective all-purpose insect repellent, N,N-diethyl-m-toluamide is often referred to as “DEET”. DEET is effective in repelling mosquitoes, black flies, carpenter ants and deer ticks. In view of the relatively small number of useful insect repellents known, many of which are toxic when applied to the epidermis of humans, efforts continue to be made to discover delivery methods for applying such repellents safely and effectively.

Whereas many insects are considered a nuisance, others have proved to be a significant health threat, particularly to children. Lyme disease and West Nile Virus are two examples of such potential threatening diseases that are transmitted by ticks and mosquitoes respectively.

### SUMMARY OF THE INVENTION

The present invention is directed to providing an improved method of delivering insect repellent. In particular it is directed to a method of delivering insect repellent which controls the amount of a repellent applied directly to garments, particularly children's garments, and which eliminates or reduces the direct application of the repellent to the epidermis of a human to ward off the insects.

In particular, the invention includes an improved method of applying insect repellent to clothes as part of the rinse cycle of a washing machine. In particular the invention is directed to delivering the insect repellent with fabric softener to articles within an automatic clothes washer for providing soft, treated garments that repel insects.

Prior art methods have included incorporating insect repellents into detergents that are added to the to the wash cycle of an automated washing machine. This method suffers from diminished retention during the rinse cycle. Other prior art methods have included adding insect repellents to an automated clothes dryer in the form of a dryer sheet containing the repellent and releasing the repellent while the clothing is drying. This method, in particular, suffers from the limited fluid medium available for transferring the repellent from the dryer sheet to the clothing in the dryer, thus imparting a limited repellence. These and other limitations in the prior art are overcome by the present invention.

It is a first aspect of the present invention to provide a method of manufacturing an article of manufacture comprising the steps of manufacturing a fabric softener and, including an amount of an insect repellent as a component of the fabric softener.

It is a second aspect of the present invention to provide a method of imparting insect repellence to an article, the method comprising the step of adding an amount of insect repellent to an article within a washing machine during a rinse cycle.

### DETAILED DESCRIPTION OF THE PREFERRED EMBODIMENT

It should be understood that the following detailed description of exemplary embodiments of the invention are exemplary in nature and shall not constitute limitations upon the invention. It is also to be understood that the exemplary embodiments shall enable one of ordinary skill in the art to practice the invention without undue experimentation, and variations of the exemplary embodiments contemplated by one of ordinary skill in the art shall concurrently fall within the scope and spirit of the invention. Although certain aspects of the exemplary embodiments disclosed in more detail, some obvious alternate features may have been omitted for the sake of clarity and brevity.

The present invention includes a method of adding an insect repellent, for example, N,N-diethyl-m-toluamide (hereinafter “DEET”), to articles (generally clothing) during the rinse cycle of an automated washing machine. The method also includes adding an insect repellent individually or in combination with one or more components such as, for example, fabric softener during the rinse cycle. The method provides articles, particularly clothing, with the ability to repel insects such as mosquitoes so as to minimize the likelihood that a human in proximity to the articles will become the target of an insect bite. When the articles are clothing, the invention provides a method of supplying an insect repellent without resorting to applying the insect repellent directly to the epidermis of the human. The present invention also includes a method of producing an article of manufacture such as a fabric softener that includes an insect repellent.

Various insect repellents are known within the art and an exhaustive list of such has been omitted for purposes of brevity. While the present invention is explained below utilizing DEET as the insect repellent, is should be understood by one of ordinary skill that alternative insect repellents may be utilized in lieu of or in addition to DEET.

The present invention centers around adding a insect repellent to articles during the rinse cycle of a washing machine. During the rinse cycle, detergent and stains are dissolved into the fluid medium, while the insect repellent is added to the fluid medium and disseminates throughout the fluid medium and articles within the washing machine and is retained by the contents of the washing machine as the fluid medium is partially removed. As the damp articles are removed from the washing machine and subsequently dried, the insect repellent is retained therein as the fluid medium is removed.

While there are various application rates of DEET that produce the desired effect of repelling insects from articles under different conditions, it has been found sufficient to provide along the order of 1 fluid ounce of DEET to the articles during the rinse cycle of an automated washing machine. It has been found that this amount of DEET added during the rinse cycle results in insect repellence of approximately 24 hours while the article is being used, and also provides an extended insect repellence for stored articles of approximately one month. It is also within the scope and spirit of the present invention to add less than 1 fluid ounce or more than 1 fluid ounce to increase the concentration of DEET retained by the articles after the rinse cycle is complete. For example, if the articles may be exposed to elevated temperatures for an extended period, say 2 hours or more, the amount of DEET added during the rinse cycle may be higher to compensate for the higher amount of DEET emanating from the articles at the elevated temperatures.

It has also been found that when chemicals, such as fabric softeners, are added to the rinse cycle, the amount of DEET added may generally be diminished. It has been discovered that a ratio of 4:1 to 5:1 (in fluid ounces) of fabric softener and/or other components to DEET provides the desired effect of repelling insects from the articles. However, higher or lower ratios may be utilized depending upon the conditions of intended use of the articles or the intended duration of insect repellence. As discussed above, the ratio may be diminished along the lines of 1:1 to 2:1 to impart insect repellence in accordance with increased exposure to elevated temperatures, and/or to provide insect repellence during a longer duration.

It is to be understood that while the foregoing explanation has been described utilizing an automated washing machine, washing machines such as dry cleaning machines and other cleaning processes are within the scope and spirit of the present invention. It is also to be understood that various compositions of fabric softener are within the purview of one of ordinary skill, and need not be explained in a detailed component form to enable one of ordinary skill to practice the present invention.

What is claimed is:

1. A method of manufacturing an article of manufacture comprising the steps of:
manufacturing a fabric softener; and,
including an amount of an insect repellent as a component of the fabric softener.

2. The method of claim 1, wherein the insect repellent is N,N-diethyl-m-toluamide.

2. The method of claim 2, wherein the amount of N,N-diethyl-m-toluamide added to the fabric softener constitutes up to and including 50 percent of the fabric softener.

3. The method of claim 2, wherein the amount of N,N-diethyl-m-toluamide added to the fabric softener is between 25 to 50 percent of the fabric softener.

4. The method of claim 2, wherein the amount of N,N-diethyl-m-toluamide added to the fabric softener is between 10 to 25 percent of the fabric softener.

7. A method of imparting insect repellence to an article, the method comprising the step of adding an amount of insect repellent to an article within a washing machine during a rinse cycle.

8. The method of claim 7, wherein the insect repellent is N,N-diethyl-m-toluamide.

9. The method of claim 8, wherein the amount of N,N-diethyl-m-toluamide added is approximately 1 fluid ounce.

10. The method of claim 8, wherein the amount of N,N-diethyl-m-toluamide is added automatically.

11. The method of claim 10, wherein the amount of N,N-diethyl-m-toluamide is held within a container inside of the washing machine before the rinse cycle.
